(19) United States
(12) Patent Application Publication
(10) Pub. No.: US 2006/0004577 A1
(43) Pub. Date: Jan. 5, 2006

(54) Distributed speech synthesis system, terminal device, and computer program thereof

(76) Inventors: Nobuo Nukaga, Tokyo (JP); Toshihiro Kujirai, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/030,109

(22) Filed: Jan. 7, 2005

(30) Foreign Application Priority Data
Jul. 5, 2004 (JP) 2004-197622

(51) Int. Cl. G10L 13/06

(52) U.S. Cl. 704/267

(57) ABSTRACT

In the text-to-speech synthesis technique for synthesizing speech from text, this invention enables a terminal device with relatively small computing power to perform speech synthesis based on optimal unit selection. The text-to-speech synthesis procedure of the present invention involves content generation and output; that is, a secondary content including the results of the optimal unit selection process is output. By virtue of the secondary content, a high load process of selecting optimal units and a light load process of synthesizing speech waveforms can be performed separately. The optimal unit selection process is performed at a server and information for the units to be retrieved from a corpus is sent to the terminal as data for speech synthesis.

### CLAIM OF PRIORITY

The present application claims priority from Japanese application JP 2004-197622 filed on Jul. 5, 2004, the contents of which is hereby incorporated by reference into this application.

### FIELD OF THE INVENTION

The present invention relates to a text-to-speech synthesis technique for synthesizing speech from text. In particular, this invention relates to a distributed speech synthesis system, terminal device, and computer program thereof, which are highly effective in a situation where information is distributed to a mobile communication device such as in-vehicle equipment and mobile phones and speech synthesis is performed in the mobile device for an information read-aloud service.

### BACKGROUND OF THE INVENTION

Recently, speech synthesis techniques that convert arbitrary text into speech have been developed and applied to a variety of devices and systems such as car navigation systems, automatic voice response equipment, voice output modules of robots, and health care devices.

For instance, for an information distribution system where text data that has been input to a server is transmitted over a communication channel to a terminal device where the text data is converted into speech information output, the following functions are essential: a language processing function to generate intermediate language information for pronunciation information corresponding to the input text data; and a speech synthesis function to generate synthesized speech information by synthesizing speech from the intermediate language information.

As for the former language processing function, a technique has been disclosed, e.g., in Japanese Patent Laid-Open No. H11(1999)-265195. In the Japanese Patent Laid-Open No. H11-265195, a system is disclosed where text data is analyzed and converted into intermediate language information for speech synthesis in later speech synthesis processing and the information in a predetermined data form is transmitted from a server to a terminal device.

Meanwhile, as for the latter speech synthesis function, the voice quality of text-to-speech synthesis was so largely inferior to the voice quality provided by a recording/playback system in which recorded human voice waves are concatenated and output that people called it “machine's voice” formerly. However, the difference between both has been reduced with the recent advance of speech synthesis technology.

As a method for improving the voice quality, a “corpus-base speech synthesis approach” in which optimal units (fragments of speech waveforms) are selected from a large volume of speech database and speech synthesis is performed has achieved a successful outcome. In the corpus-base speech synthesis approach, the algorithms for estimations approximating to the quality of synthesized speech are used in selecting units and, therefore, designing the estimation algorithms is a major technical challenge. Prior to the introduction of the corpus-base speech synthesis approach, researches had no other choice than relying on their experimental knowledge to improve the synthesized speech quality. However, in the corpus-base speech synthesis approach, synthesized speech quality improvement can be effected by developing a better design method of the estimation algorithms and this technique has an advantage that it can be shared widely.

There are two types of corpus-base speech synthesis systems. One is, in a narrow sense, unit concatenative speech synthesis. In this approach, synthesized speech is generated from optimal speech waveforms selected by criteria called cost functions and waveforms are directly concatenated without being subjected to prosodic modifications when they are synthesized. In another approach, prosodic and spectrum characteristics of selected speech waveforms are modified through the use of a signal processing technique.

An example of the former is a system described in the following document (hereafter, document 1).

A. J. Hunt and A. W. Black, “Unit selection in a concatenative speech synthesis system using a large speech database,” Proc. IEEE-ICASSP' 96, pp. 373-376, 1996

In this system, two cost functions which are called a target cost and a concatenation cost are used. The target cost is a measure of difference (distance) between a target parameter generated from a model and a parameter stored on the corpus database. The target parameter includes a basic frequency, power, duration, and spectrum. The concatenation cost is calculated as a measure of distance between concatenated parameters for concatenation of two consecutive units of waveforms. In this system, the target cost is calculated as the weighted sum of target sub-costs and the concatenation cost is also determined as the weighted sum of concatenation sub-costs and an optimal sequence of waveforms is determined by dynamic programming to minimize the total cost, the estimated sum of the target and concatenation costs. In this approach, designing the cost functions in selecting waveforms is very important.

An example of the latter is a system described in the following document (document 2).

Y. Stylianou, “Applying the Harmonic Plus Noise Model in Concatenative Speech Synthesis,” IEEE Transactions on Speech and Audio Processing, Vol. 9, No. 1, pp. 21-29, 2001

In this system, estimation algorithms like those employed in the above system according to the document 1 are used in selecting units, but the concatenation of the units is modified by using a signal processing technique.

### SUMMARY OF THE INVENTION

While speech synthesis has been so improved as to achieve a voice quality level near to human voice by using the corpus-base speech synthesis technique, as described above, the corpus-base speech synthesis technique has a drawback that a great amount of calculation is required in the process of selecting target units from a large amount of waveforms and synthesizing the selected waveforms. The waveform data amount required for conventional built-in type speech synthesis systems in general application ranges from several hundred bytes to several megabytes, whereas the waveform data amount required for the above corpus-base speech synthesis system ranges from several hundred megabytes to several gigabytes. Consequently, time is taken for access processing to a disk system for storing the waveform data.

When a large system for speech synthesis, as above, is incorporated into a system with relatively small computer resources such as a car navigation system and a mobile phone, such a problem would occur that considerable time is required before completing the synthesis of speech that should be vocalized and the start of announcement and, in consequence, intended operation cannot be accomplished.

The object of the present invention is to provide a distributed speech synthesis system, terminal device, and computer program thereof, which enable implementing text-to-speech synthesis and output in a system with relatively small computer resources such as a car navigation system and a mobile phone, while ensuring the language processing function and the speech synthesis function for high-quality speech synthesis.

A typical aspect of the invention disclosed in this application, which has been contemplated to solve the above problem, will be summarized below.

In general, in the corpus-base speech synthesis system, tasks are roughly divided into two processes: a unit selection process in which input text is analyzed and a string of target units is selected and a waveform generation process in which signal processing is performed on the selected units and waveforms are generated. In the present invention, the impact of difference between the amount of processing required for the unit selection process and that for the waveform generation process is considered and these processes are performed in separate phases.

One feature of the present invention lies in that the text-to-speech synthesis process which synthesizes speech from text is divided into a unit of generating a secondary content furnished with information for access to a speech database and retrieval of optimal units selected by analyzing text data included in a primary content distributed via a network and a unit of synthesizing speech corresponding to the text data, based on the secondary content and the speech database. It is desirable that these two units are separately assigned to a processing server and a terminal device; however, either the processing server or the terminal device may undertake a part of each unit assigned to the other. A part of each unit may be processed redundantly in order to obtain processing results at a high level.

According to the present invention, in an environment where a processing server and a terminal device can be connected via a network, the unit of generating the secondary content and the unit of synthesizing speech corresponding to text data, based on the secondary content and the speech database are separated. Therefore, for instance, the following can be implemented: the optimal unit selection process is performed at the processing server and information with regard to waveforms obtained as the results of the optimal unit selection process is only sent to the terminal device. In consequence, the processing burden on the terminal device including sending and receiving content data can be reduced greatly. Thus, high-quality speech synthesis is feasible on a device with a relatively small computing capacity. The resulting load is not so large as to constrict other computing tasks to be performed on the computer and the response rate of the entire device and consumed power can be improved, as compared with prior art devices.

### BRIEF DESCRIPTION OF THE DRAWINGS

FIG. 1A shows an example of the configuration of a distributed speech synthesis system as one embodiment of the present invention.

FIG. 1B shows the units (functions) belonging to each of the components of the system shown in FIG. 1A.

FIG. 2 shows an example of a system configuration for another embodiment of the present invention.

FIG. 3 shows a transaction procedure between a terminal device and a processing server when content is sent from the processing server in one embodiment of the present invention.

FIG. 4 shows an exemplary data structure that is sent between the terminal device and the processing server in one embodiment of the present invention.

FIG. 5 shows an exemplary management table in one embodiment of the present invention.

FIG. 6A shows an exemplary secondary content.

FIG. 6B shows another exemplary secondary content.

FIG. 6C shows a further exemplary secondary content.

FIG. 7 shows an example of the process of selecting optimal units at the processing server in one embodiment of the present invention.

FIG. 8 shows an example of the process of outputting speech at the terminal device in the present invention.

FIG. 9A shows the units (functions) belonging to each of the components of a system of another embodiment of the present invention.

FIG. 9B shows a transaction procedure between the terminal device and the processing server in a situation where a content request is sent from the terminal device.

FIG. 10 shows a transaction procedure between the terminal device and the processing server in a situation where the processing server creates content beforehand in the system of another embodiment of the present invention.

FIG. 11 shows another example of the process of outputting speech at the terminal device in the present invention.

FIG. 12A shows another example of the steps for outputting speech at the terminal device, based on the secondary content, in one embodiment of the present invention.

FIG. 12B shows an exemplary secondary content for the embodiment shown in FIG. 12A.

FIG. 13 shows one example of a speech database management scheme at the processing server in the present invention.

FIG. 14 shows one example of a management scheme of waveform IDs in a speech database in the present invention.

### DETAILED DESCRIPTION OF THE PREFERRED EMBODIMENTS

Illustrative embodiments of the distributed speech synthesis method and system according to the present invention will be discussed below, using the accompanying drawings.

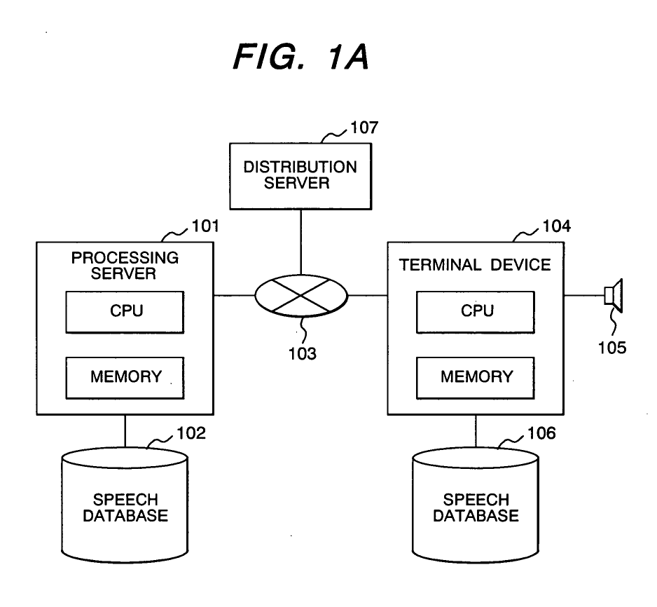

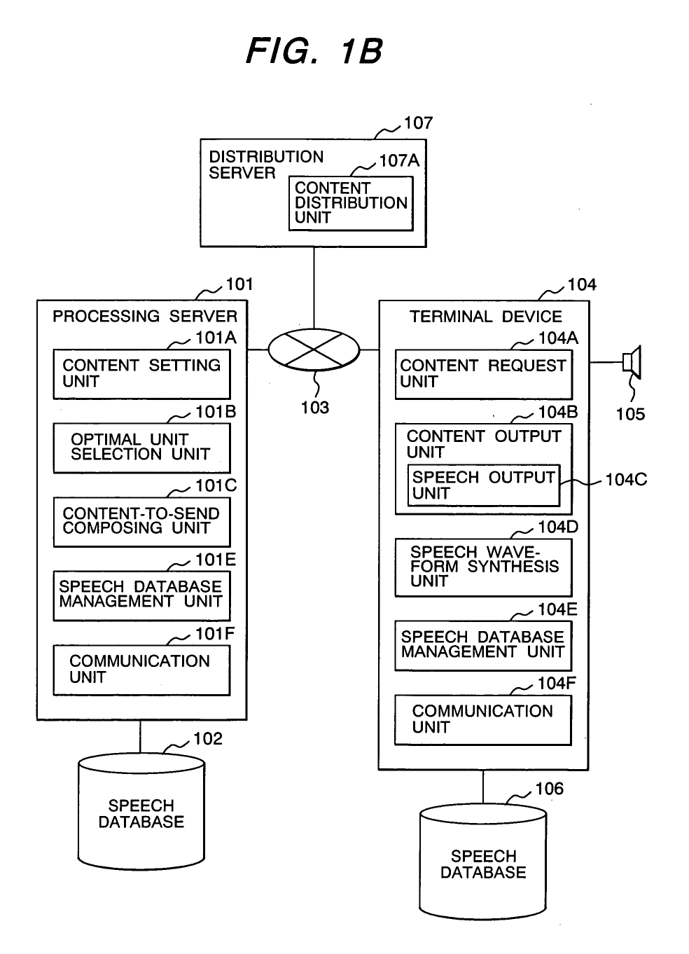

First, one embodiment of the distributed speech synthesis system according to the present invention is described with FIGS. 1A and 1B. FIG. 1A shows an example of the system configuration of one embodiment in which the present invention is carried out. FIG. 1B is a diagram showing the units (functions) belonging to each of the components of the system shown in FIG. 1A.

The distributed speech synthesis system of this invention is made up of a processing server 101 which performs language processing or the like for text that has been input, generates speech information, and sends that information to a terminal device 104, a speech database 102 set up within the processing server, a communication network 103, speech output device 105 which outputs speech from the terminal device, a speech database 106 set up within the terminal device, and a distribution server 107 which sends content to the processing server 101. The servers and terminal device are embodied in computers with databases or the like, respectively, and the CPU of each computer executes programs loaded into its memory so that the computer will implement diverse units (functions). The processing server 101 is provided, as main functions, with a content setting unit 101A which performs setting on content received from the distribution server 107, an optimal unit selection unit 101B which performs processing for selecting optimal units for speech synthesis on the set content, a content-to-send composing unit 101C which composes content to send to the terminal device, a speech database management unit 101E, and a communication unit 101F, as shown in FIG. 1B. The terminal device 104 is provided with a content request unit 104A, a content output unit 104B including a speech output unit 104C, a speech waveform synthesis unit 104D, a speech database management unit 104E, and a communication unit 104F. The content setting unit 101A and the content request unit 104A are implemented with a display screen or a touch panel or the like for input. The content output unit 104B comprises the unit of outputting synthesized speech as content to the speech output device 105 and, when the content includes text and images to be displayed, the unit of outputting the text and images to the display screen of the terminal device simultaneously with the speech output. The distribution server 107 has a content distribution unit 107A. The distribution server 107 may be integrated into the processing server 101; that is, the content distribution unit may be built into a single processing server.

In this system configuration example, an identification scheme in which at least a particular waveform can be uniquely identified must be used commonly for both the speech databases 102 and 106. For instance, serial numbers (IDs) that are uniquely assigned to all waveforms existing in the speech databases are an example of the above common identification scheme. Phonemic symbols to identify phonemes and a complete set of serial numbers corresponding to the phonemic symbols are also examples of such scheme. For example, when N waveforms of a phoneme “ma” exist in the databases, reference information (ma, i) where i≦N is an example of the above common identification scheme. Reasonably, when both the speech databases 102 and 106 have completely identical data, this is an instance of common use of the above identification scheme.

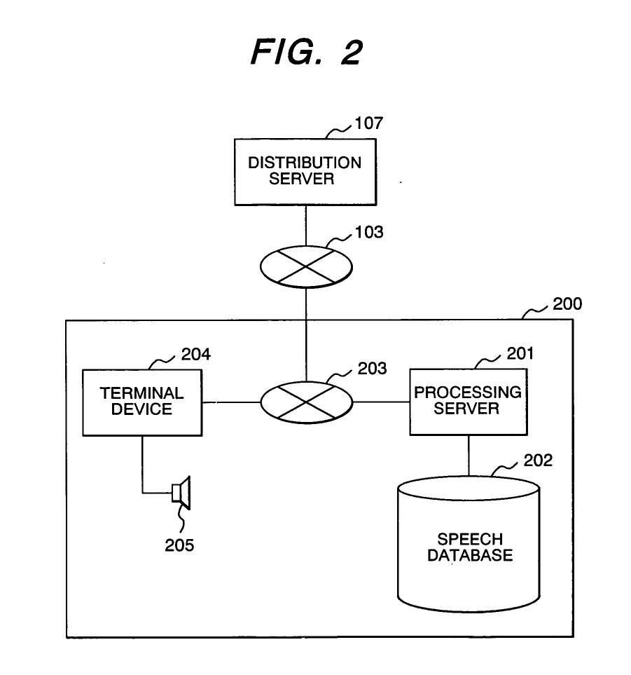

FIG. 2 shows an example of a system configuration with an automobile or the like which was taken as an concrete application of the present invention. The distributed speech synthesis system of this embodiment is made up of chassis equipment 200, a processing server 201, a speech database 202 connected to the processing server 201, a communication path 203 for communication within the chassis equipment, a terminal device 204 with a speech output device 205, and a distribution server 207 for information distribution. Unlike the embodiment shown in FIG. 1A, the speech database 202 is not connected to the terminal device 204. In this embodiment, the processing server 201 undertakes processing with waveform data required for the terminal device 204. Needless to say, when the processing capacity of the terminal device 204 permits, it may be implemented that the speech database 202 is connected to the terminal device 204 and the terminal device performs processing with waveform data, as is the case for the embodiment shown in FIG. 1A.

Here, the chassis equipment 200 is embodied in, for example, an automobile or the like. As the in-vehicle processing server 201, a computer having higher computing capacity than the terminal device 204 is installed. The chassis equipment 200 in which the processing server 201 and the terminal device 204 are installed is not limited to a physical chassis; in some implementation, the chassis equipment may be embodied in a virtual system such as, e.g., an intra-organization network or Internet. The main functions of the processing server 201 and the terminal device 204 are the same as shown in FIG. 1B.

In either of the above examples shown in FIGS. 1 and 2, the distributed speech synthesis system primarily consists of the processing server (processing server 101 in the first embodiment and processing server 201 in the second embodiment) that generates and outputs content through required processing for speech synthesis on content received from the distribution server and the terminal device (terminal device 104 in the first embodiment and terminal device 204 in the second embodiment) that outputs speech, based on the above content. Therefore, although information exchange between the processing server and the terminal device will be described below on the basis of the system configuration example of FIG. 1, it is needless to say that information sending and receiving steps can be replaced directly with those steps between the terminal device 204 and the processing server 201 in the system configuration example of FIG. 2.

In the following description, when discrimination between contents is necessary, original content sent from the distribution server is referred to as a primary content and content furnished with information for access to the speech database and retrieval of optimal units selected by analyzing text data included in this primary content is referred to as a secondary content.

This secondary content is intermediate data that comprises intermediate language information furnished and information for access to the speech database and retrieval of selected optimal units and, based on this secondary content, a process of generating waveforms, namely, a process of synthesizing speech waveforms is further performed and synthesized speech is output from the speech output device.

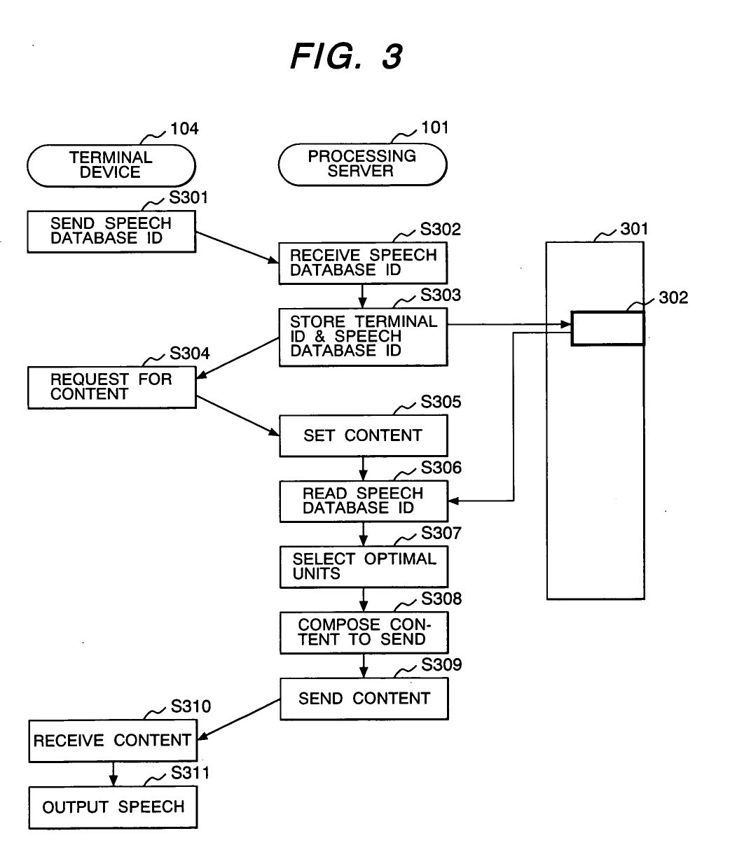

Then, an embodiment of communication where the secondary content generated at the processing server by furnishing intermediate language information and furnishing information for access to the speech database and retrieval of optimal units selected by analyzing the primary content is sent to the terminal device is described in detail, using FIGS. 3 through 7.

Processes to be discussed below cover sending the secondary content generated at the processing server 101 through processing for speech synthesis on the primary content and vocalizing text information such as traffic information, news, etc., with synthesized speech, based on the secondary content, at the terminal device 104.

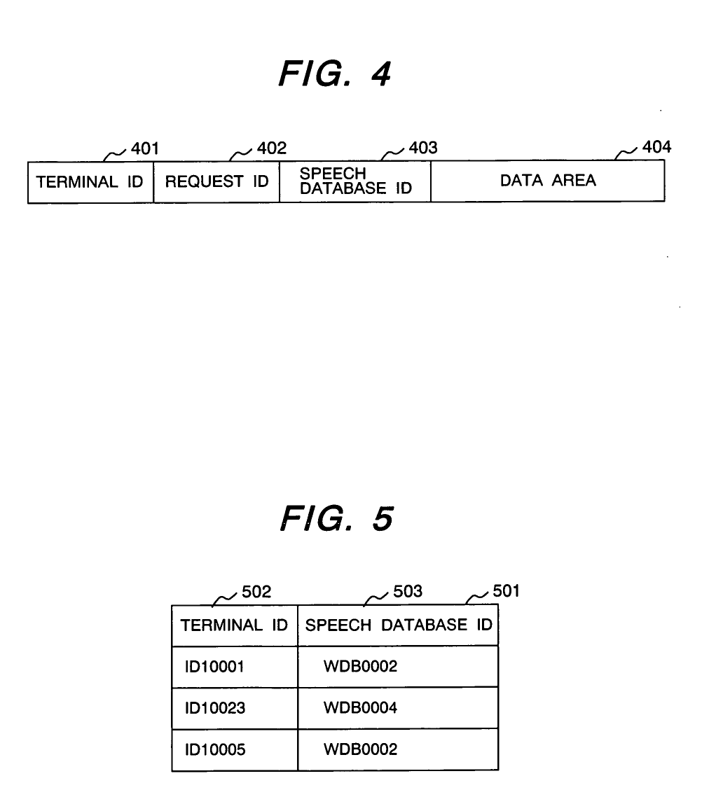

FIG. 3 shows an example of transactions to be performed between the processing server 101 and terminal device 104 in FIG. 1 (or the processing server 201 and terminal device 204 in FIG. 2); that is, an exemplary transaction procedure for sending and receiving content. FIG. 4 shows an exemplary data structure that is sent and received between the terminal device 104 and the processing server 101. FIG. 5 shows an exemplary management table in which information about the terminal device 104 is registered.

First, the terminal device 104 sends a speech database ID to the processing server 101 (step S301). At this time, data to send is created by setting information specific to the terminal for the terminal ID 401, request ID 402, and speech database ID 403 in the data structure of FIG. 4. The speech database ID that is sent in this step S301 is stored in the field 403 in the data structure of FIG. 4. In step S302, the processing server 101 receives the data, reads the speech database ID from the received data, and stores the ID information about the terminal 104 into a speech database ID storage area 302 in the memory space 301 provided within the processing server 101.

The ID information about the terminal 104 is managed, e.g., in the management table 501 shown in FIG. 5. The management table 501 consists of a terminal ID 502 column and a speech database ID 503 column. In the example of FIG. 5, three terminal IDs are stored as terminal ID entries and the IDs of the speech databases existing on the terminals are stored associatively. For example, a speech database WDB0002 is stored, associated with a terminal ID10001. Likewise, a speech database WDB0004 is stored, associated with a terminal ID10023; and a speech database WDB0002 is stored, associated with a terminal ID10005. Here, the same speech database ID is stored for the two terminals, ID 10001 and ID10005, indicating that the identical speech databases exist on these terminals.

Returning to FIG. 3, in step S303, the above management table is stored into the memory area 302 within the processing server 101. When the features of the waveform units existing on the terminal are unknown to the processing server, the processing server cannot select optimal units in the later unit selection process. This step is provided so that the processing server can identify waveform units data existing on the terminal.

Next, the terminal device 104 sends a request for content distribution to the processing server 101 (step S304). Having received this request, the processing server 101 receives a primary content by the request from the distribution server 107 and sets details of the content to be distributed after being processed (step S305). For example, when the requested content is regular news and weather forecast, unless specified particularly, the processing server sets the latest regular news and weather forecast to be distributed as the content. When a particular item of content is specified, the processing server searches for it and determines whether it can be processed and distributed; if so, the server sets it as the content to be distributed.

Next, the processing server 101 reads the speech database ID associated with the terminal device 101 from which it received the request for content from the memory area 302 (step S306). Then, the processing server 101 analyzes text data of the set content, e.g., regular news, and selects optimal units for vocalizing the content to be distributed from the speech database identified by the speech database ID (step S307), composes a secondary content to be distributed (step S308), and sends the secondary content to the terminal device 104 (step S309). The terminal device 104 synthesizes speech waveforms in accordance with the received secondary content (step S310) and outputs synthesized speech from the speech output device 105 (step S311).

As is obvious from above steps, according to the present embodiment, it becomes possible to separate a series of processes of converting text data to speech up to speech output, which was conventionally performed entirely at the terminal device 104, into two phases: a process of generating the secondary content, which comprises analyzing text data, selecting optimal units, and converting text to speech data, and a process of synthesizing speech waveforms, based on the second content. Thus, on the assumption that the terminal device and the processing server have the speech databases in which data units are identified by the common identification scheme, the secondary content generating process can be performed at the server 101 and the processing load at the terminal device 104 including sending and receiving content data can be reduced greatly.

Therefore, even the terminal device with a relatively small computing capacity can synthesize speech at a high quality level. The resulting load at the terminal device is not so large as to constrict other computing tasks to be performed by the terminal device 104 and the response rate of the entire system can be enhanced.

It is not necessary to restrict the procedure of the series of processes of converting text data to speech up to speech output to the above procedure in which the server 101 and the terminal device 104 respectively undertake the two phases of processes: i.e., the secondary content generating process comprising analyzing text data, selecting optimal units, and converting text to speech data and the speech waveforms synthesizing process based on the second content to perform. As in the foregoing system configuration example of FIG. 2, when the processing capacity of the server is greater, a part of the speech waveform synthesis based on the secondary content may be executed on the server 101.

Then, a speech synthesis process for generating the secondary content at the processing server 101, which is a feature of the present invention, is described in detail.

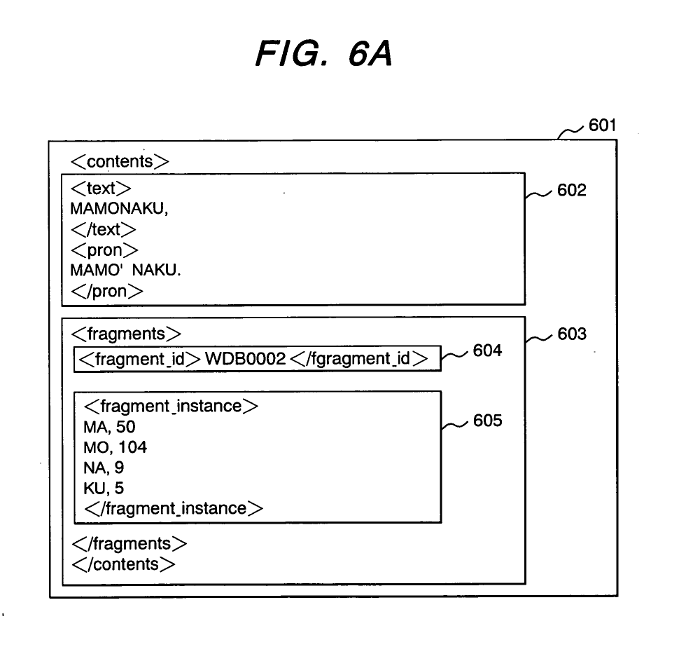

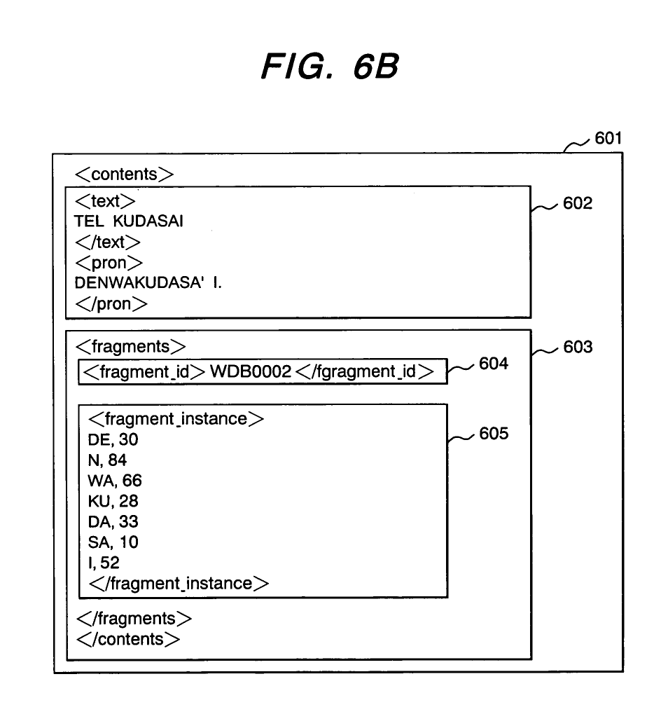

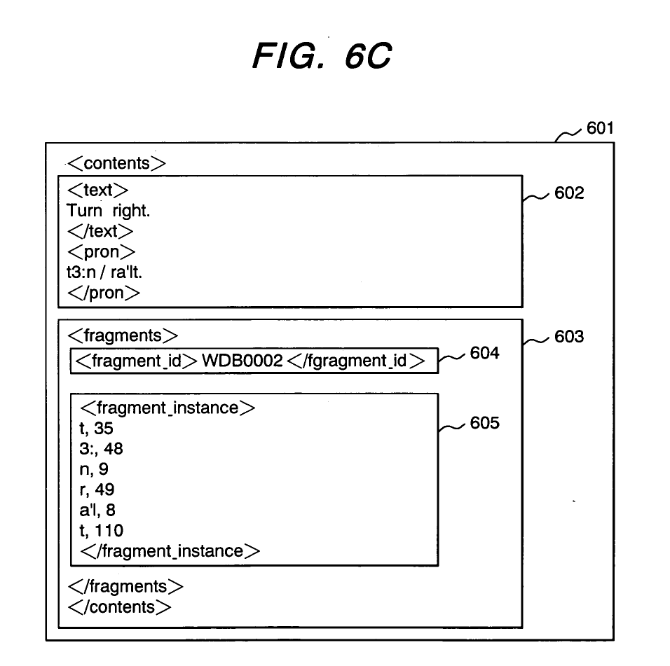

An embodiment of processing for selecting optimal units in the step S307 and a secondary content organization that is sent, included in the above embodiment, are first described, using FIGS. 6A through 6C.

FIG. 6A shows an exemplary secondary content that is sent after generated by converting text to speech data at the processing server 101. The secondary content 601 is intermediate data for synthesizing and outputting speech waveforms and consists of a text part 602 and a waveform information part 603 where waveform reference information is described. In the text part 602, information from the primary content, that is, text (text) to be vocalized and a string of phonetic symbols such as, e.g., intermediate language information (pron) resulting from analyzing the text are stored. In the waveform information part 603, information for access to a speech database and retrieval of optimal units selected by analyzing the text data is furnished. In fact, speech database ID information 604, waveform index information 605, and like for the waveform units selected to synthesize the speech corresponding to the text in the text part 602 are stored in the waveform information part 603. In this example, the text (text) of a word “mamonaku” (=soon in English) and its phonetic symbols (pron) are described in the text part 602 and waveform information to synthesize the speech for the “mamonaku,” that is, speech database ID WDB0002 to be accessed is specified in the box 604 and waveform IDs 50, 104, 9, and 5 selected respectively for the phonemes “ma,” “mo,” “na,” and “ku,” which are to be retrieved from the database, are specified in the waveform index information 605 box. By using the above description as the secondary content, the terminal device can obtain the information for optimal waveform units of the speech for the text “mamonaku” without selecting these units.

The structure of the secondary content 601 is not limited to the above example of embodiment, the text part 602 and the waveform information part 603 may be composed of data that can uniquely identify phonetic symbols and waveform units corresponding to text. For example, it is preferable that a speech database should be constructed to include the waveform units for frequently used alphabet letters and pictograms so as to have adaptability to, as input text, not only text consisting of mixed kana and kanji characters, but also text consisting of Japanese characters mixed with alphabet letters which is often used in news and e-mail.

By way of example, when “TEL kudasai.” (=phone me in English) is input as the text, as shown in FIG. 6B, it is converted to “denwakudasa' i” as a string of phonetic symbols (pron) and the IDs of selected waveform units, 30, 84, . . . for “de,” “n” and so on are specified for retrieval from the database in the waveform index information 605 box.

As another example, when an English sentence “Turn right.” is input as the text, as shown in FIG. 6C, it is converted to phonetic symbols “T3:n/ra'lt.” in English as a string of phonetic symbols (pron) and the IDs of selected waveform units, 35, 48, . . . for “t,” “3:” and so on are specified for retrieval from the database in the waveform index information 605 box.

When image information is attached to input text, synchronization information for synchronizing the input text and associated image information is added to the secondary content 601 structure so that the content output unit 104B of the terminal device can output speech and images simultaneously.

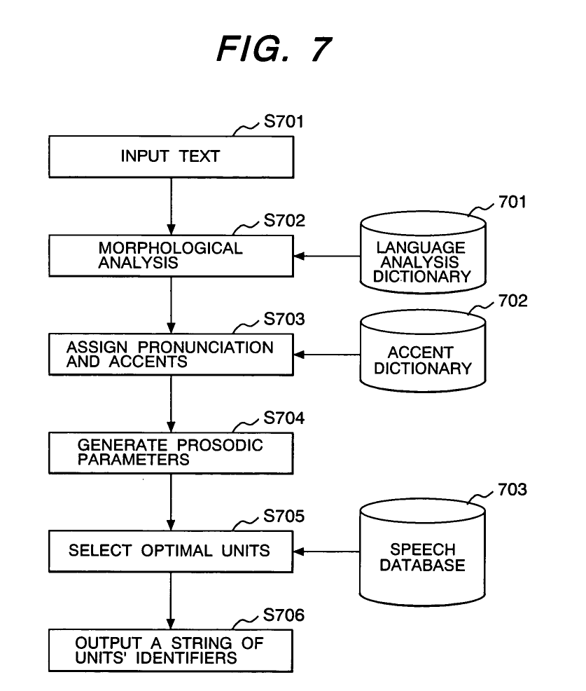

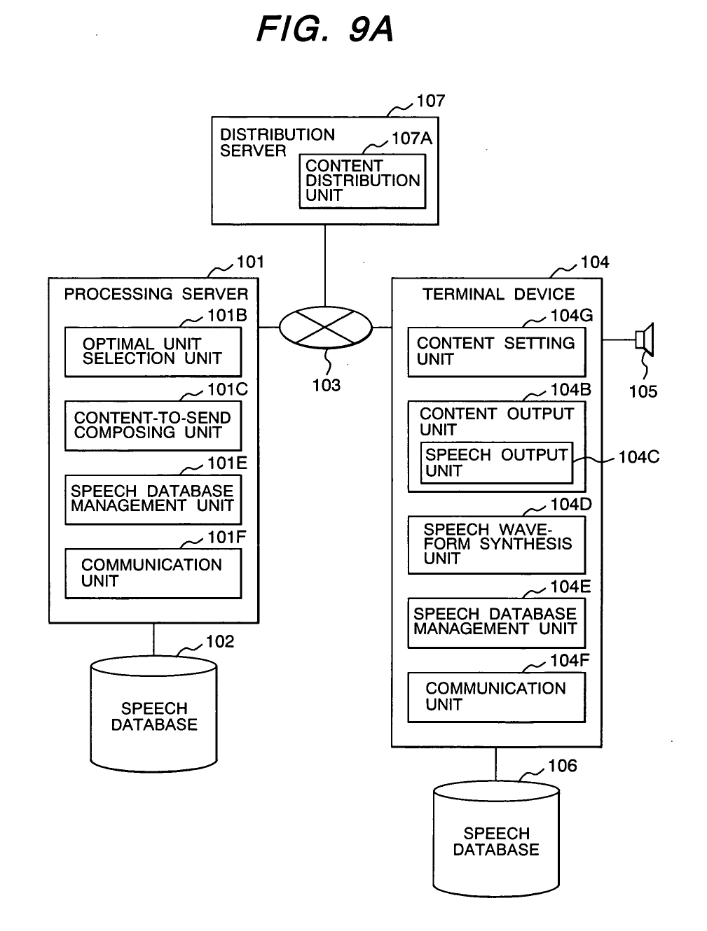

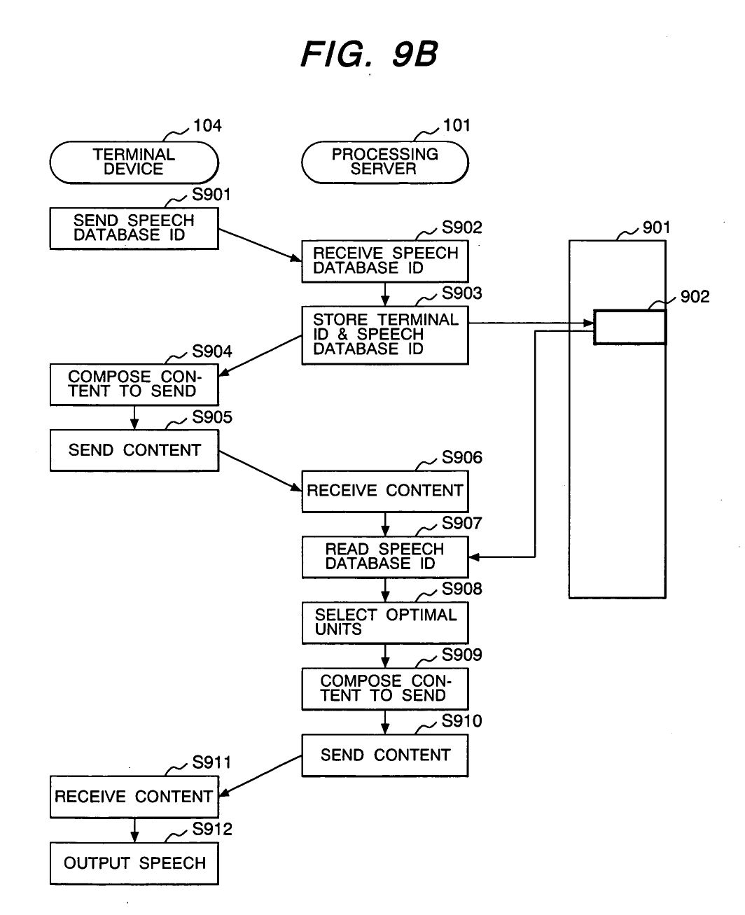

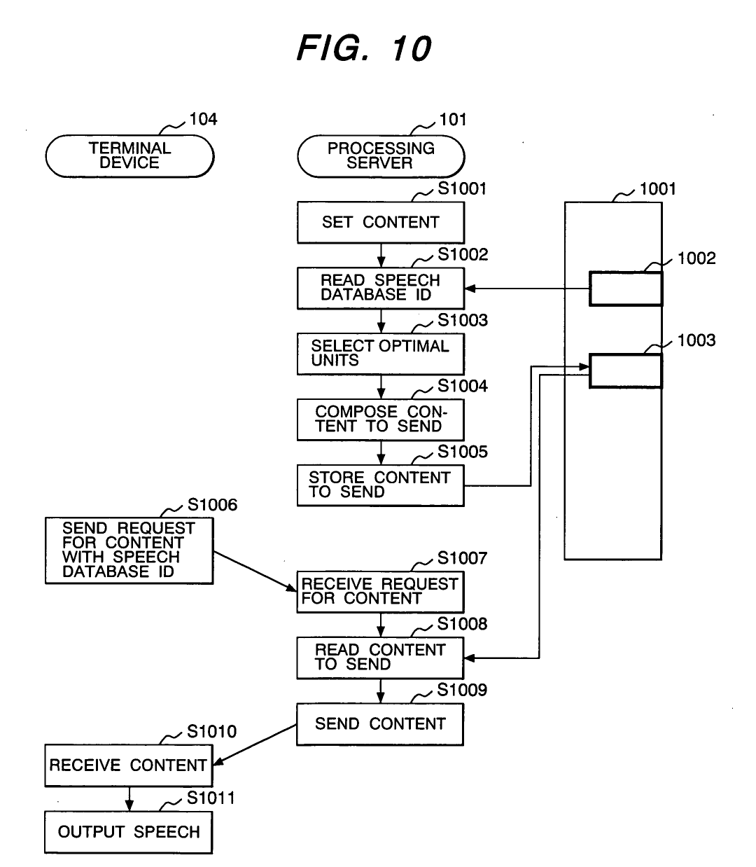

Next, a detailed process of selecting optimal units at the processing server 101, which is performed in the step S307 in FIG. 3, is described, using FIG. 7. The process corresponding to this step includes generating intermediate language. The process detail of a step S908 in FIG. 9B and a step S1003 in FIG. 10, which will be described later, it is the same as the step S307.

In the process of selecting optimal units, first, morphological analysis of the primary content, or input text is performed by reference to a language analysis dictionary 701 (steps S701, S702). Morphemes refer to linguistic structural units of text. For example, a sentence “Tokyo made jutaidesu.” can be divided into five morphemes: Tokyo; made; jutai; desu:, and a period. Here, a period is taken as a morpheme. Morphemes information is stored in the language dictionary 701. In the above example, information for the morphemes “Tokyo,” “made,” “jutai,” “desu,” and the “period,” e.g., parts of speech, concatenation information, pronunciations, etc. can be found in the language dictionary. For the results of the morphological analysis, pronunciations and accents are then determined and a string of phonetic symbols is generated (step S703). In general, assigning accents comprises searching an accent dictionary for accents relevant to the morphemes and accent modification by a rule of accent coupling. The above sentence example is converted to a string of phonetic symbols “tokyoma' de judaide' su>.” In this string of phonetic symbols, an apostrophe (') denotes the position of an accent nucleus, a symbol “|” denotes a pause position, a period “.” denotes the end of the sentence, and a symbol “>” denotes that the phoneme has an unvoiced vowel. In this way, the string of phonetic symbols is made up of not only the symbols representing the phonemes but also the symbols corresponding to prosodic information such as accents and pause. The notation of phonetic symbol strings is not limited to the above.

For the string of phonetic symbols converted from the text, the prosodic parameters are then generated (step S704). Generating the prosodic parameters comprises generating a basic frequency pattern that determines the patch of synthesized speech and generating duration that determines the length of each phoneme. The prosodic parameters of synthesized speech are not limited to the above basic frequency pattern and duration; for instance, generating a power pattern that determines the power of each phoneme may be added.

Based on the prosodic parameters generated in the preceding step, a set of units are selected per phoneme to minimize an estimation function F, which are retrieved by searching the speech database 703 (step S705), and a string of the IDs of the units obtained is output (step S706). The above estimation function F is, for example, described as a function of the total sum of distance functions f defined for all phonemes corresponding to the units, namely, “to,” “—,” “kyo,” “—,” “ma,” “de,” “ju,” “—,” “ta,” “i,” “de,” and “su>” in the above example. For example, the distance function f for the phoneme “to” can be obtained as an Euclidian distance between the basic frequency and duration of a waveform of “to” existing in the speech database 703 and the basic frequency and duration of the “to” segment obtained in step S704.

By using this definition, with regard to the string of phonetic symbols “tokyoma' de|judaide' su>.”, distance F for synthesized speech “tokyoma' de|judaide' su>.” that can be made up of waveform units stored in the speech database 703 can be calculated. Usually, in the speech database 703, a plurality of waveform candidates for a phoneme are stored; e.g., 300 waveforms for “to.” Therefore, the above distance F can be calculated for all possible combinations of waveforms N, F(1), F(2), . . . , F(N) and, from among these calculations of distance F(i), i=k with the minimum value is obtained; thus, a solution can be the k-th string of the selected units.

Because, in general, an enormous number of calculations are required for calculating all possible combinations of waveforms in the speech database, it is preferable to use a dynamic programming method to obtain F(k) that is minimum. While, in the above example, prosodic parameters are used for determining the distance f per phoneme in calculating the distance function F, evaluating the distance function F is not limited to this example; for instance, a distance to estimate spectral discontinuity occurring in unit-to-unit concatenation may be added. Through the above steps, the process for outputting a string of the IDs of optimal units from input text can be implemented.

In this way, the secondary content exemplified in FIGS. 6A through 6C is generated. The secondary content is sent from the processing server 101 to the terminal device 104 over the communication network 103. As is apparent from the examples of FIGS. 6A through 6C, the secondary content contains only a small amount of information and each terminal device can output speech synthesized with data from its speech database, based on the secondary content information.

In the manner of sending the secondary content in the present embodiment, it is sufficient to send much fewer amounts of information as compared with a situation where the processing server 101 sends information including the data for speech waveforms to the terminal device 104. By way of example, the amount of information (bytes) with regard to “ma” being sent in the secondary content is only few hundredth parts of the amount of information including the data for speech waveforms of “ma.”

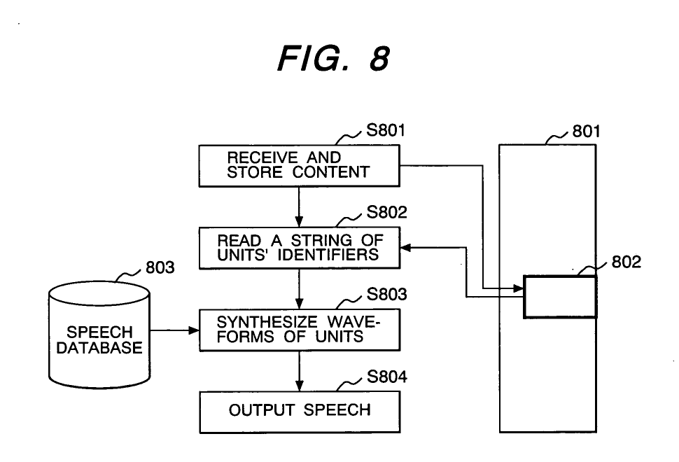

Then, an example of the steps for outputting speech at the terminal device 104, based on the above secondary content is described, using FIG. 8. First, the terminal device 104 stores the secondary content received from the processing server 101 into a content storage area 802 in its memory 801 (step 801). Then, the terminal device reads the string of the IDs of the units sent from the processing server 101 from the content storage area 802 (step S802). Next, referring to the IDs of the units obtained in the preceding step, the terminal device retrieves the waveforms identified by those IDs from the speech database 803 and synthesizes the waveforms (step S803), and outputs synthesized speech from the speech output device 105.

For example, in the secondary content example described in FIG. 6A, the 50th waveform of the “ma” phoneme, the 104th waveform of the “mo” phoneme, the 9th waveform of the “na” phoneme, and the 5th waveform of the “ku” phoneme are retrieved from the speech database 802 and, by concatenating the waveforms, synthesized speech is generated (step S803). Speech synthesis can be carried out by using, but not limited to, the above-mentioned method described in the document 1. Through the above steps, waveform synthesis using the string of optimal units set at the processing server can be performed. As above, means for synthesizing high-quality speech from a string of optimal units selected in advance can be provided at the terminal device 104 without executing the optimal unit selection process with a high processing load. The speech output method is not limited to the embodiment described in FIG. 8. The embodiment of FIG. 8 is suitable for the terminal device 104 with a limited processing capacity, as compared with another embodiment with regard to the speech output, which will be describable later.

Then, another embodiment with regard to the speech synthesis process and the output process of the present invention is described, using FIGS. 9A and 9B. In this embodiment, upon a request to vocalize a primary content, e.g., e-mail stored in the terminal device 104, the terminal device 104 requests the processing server with a high processing capacity for content conversion and receives the converted secondary content and vocalizes speech.

In this embodiment, the processing server 101 is provided, as main functions, as an optimal unit selection unit 101B, which performs processing for selecting optimal units for speech synthesis on a primary content received, a content-to-send composing unit 101C, a speech database management unit 101E, and a communication unit 101F, as shown in FIG. 9A. The terminal device 104 is provided with a content setting unit 104G which performs setting on a primary content received from the distribution server 107, a content output unit 104B including a speech output unit 104C, a speech waveform synthesis unit 104D, a speech database management unit 104E, and a communication unit 104F.

In the procedure shown in FIG. 9B, first, the terminal device 104 sends a speech database ID to the processing server 101 (step S901). Having received the speech database ID, the processing server 101 stores the terminal ID and the speech database ID into a speech database ID storage area 902 in the memory 901 (steps S902, 903). Here, the data that is stored is the same information as registered in the management table 501 shown in FIG. 5. Then, the terminal device 104 composes the primary content for which it requests the processing server for conversion (step S904).

Here, the primary content to send is the one distributed from the distribution server 107 to the terminal device 104 and this content should be converted to synthesized speech through the process of selecting optimal units, e.g., in the step S307 of FIG. 3, at the terminal device 104 normally in the prior art method. However, this content consists of data that is not suitable for the processing at the terminal device 104 because of insufficient computing capacity of the terminal device 104. For example, e-mail, news scripts, etc. of relatively great data size are taken as such content. However, the processing is not conditioned by data size and content to be vocalized is handled as the primary content regardless of its size.

At the terminal device 104, in step S904, the primary content for which the terminal device requests the processing server for conversion, which may be, e.g. a new e-mail received after the previous request for composition, is composed for the request for conversion, and the terminal device sends this primary content to the processing server 101(step S905). The processing server receives the primary content (step S906) and reads the speech database ID associated with the ID of the terminal device 104 from the storage area 902 where the management table 501 is stored and determines the speech database to access (step S907). Then, the processing server analyzes the primary content, selects optimal units (step S908), and composes content to send (secondary content) by furnishing the received content with information about the selected units. The processing server sends the secondary content to the terminal device 104 (step S910). The terminal device 104 receives the secondary content furnished with the information about the selected units (step S911), stores it into the content storage area in its memory, synthesizes the waveforms by executing the speech waveform synthesis unit, and outputs speech from the speech output device by executing the speech output unit (step S912).

Through the above steps, a method of executing the processing task on the processing server 101 for selecting optimal units for speech synthesis from content which should be processed entirely at the terminal device 104 in the conventional method can be provided. By assigning the processing server the heavy load tasks of the language process and the optimal unit selection process out of a series of processes which were all performed at the terminal device 104 conventionally, the processing burden on the terminal device 104 can be reduced greatly.

Inconsequence, high-quality speech synthesis on a device with a relatively small computing capacity becomes feasible. The resulting load at the terminal device is not so large as to constrict other computing tasks to be performed by the terminal device 104 and the response rate of the entire system can be enhanced.

Then, another embodiment of the present invention is discussed, using FIG. 10. In this embodiment, a primary content is processed and a secondary content to send is generated in advance at the processing server 101 and the processing server sends the secondary content to the terminal device 104 by request from the terminal device 104.

In this embodiment, the processing server is provided, as main functions, with a content setting unit 101A which performs setting on a primary content received from the distribution server 107, an optimal unit selection unit 101B which performs processing for selecting optimal units for speech synthesis on a primary content received, a content-to-send composing unit 101C, a speech database management unit 101E, and a communication unit 101F, as is the case for the example shown in FIG. 1B. The terminal device 104 is provided with a content request unit 104A, a content output unit 104B including a speech output unit 104C, a speech waveform synthesis unit 104D, a speech database management unit 104E, and a communication unit 104F.

In the procedure shown in FIG. 10, first, the processing server 101 receives a primary content from the distribution server 107 and sets content to send (step S1001). Then, the processing server reads the target speech database ID from storage area 1002 in its memory 1001 (step S1002). The speech database ID that is read in the step S1002 may not be the speech database ID received from the terminal at a request, unlike the foregoing embodiments. For example, the ID is obtained by looking up one of the IDs of all speech databases stored in the processing server. In the following step S1003, the processing server selects optimal units by accessing the speech database identified by the speech database ID that was read in the preceding step. Then, the processing server composes a secondary content to send, using information about a string of the units selected in the step S1003 (step S1004) and stores the secondary content associated with the speech database ID that was read in the step S1002 into a content-to-send storage area 1003 in its memory 1001 in preparation for a later request from the terminal device.

On the other hand, the terminal device 104 sends a request for content to the processing server 101 (step S1006). When sending the content request, the terminal device may send its ID as well.

The processing server 101 receives the request for content (step S1007), reads the secondary content associated with the speech database ID specified with the content request out of a set of secondary contents stored in the content-to-send storage area 1003 in its memory 1001 (step S1008), and sends the content to the terminal device 104 (step S1009). The terminal device 104 receives the secondary content furnished with the information about the selected units (step S1010), stores it into the content storage area in its memory, synthesizes the waveforms by executing the speech waveform synthesis unit, and vocalizes and outputs the secondary content from the speech output device by executing the speech output unit (step S1011).

In this embodiment, secondary contents are composed in advance at the processing server 101 and this manner is quite effective when it is applied to primary content which is preferably sent without a delay upon a request from a terminal device, e.g., real-time traffic information, morning news, etc. However, in the embodiment of FIG. 10, primary content types are not limited to specific ones.

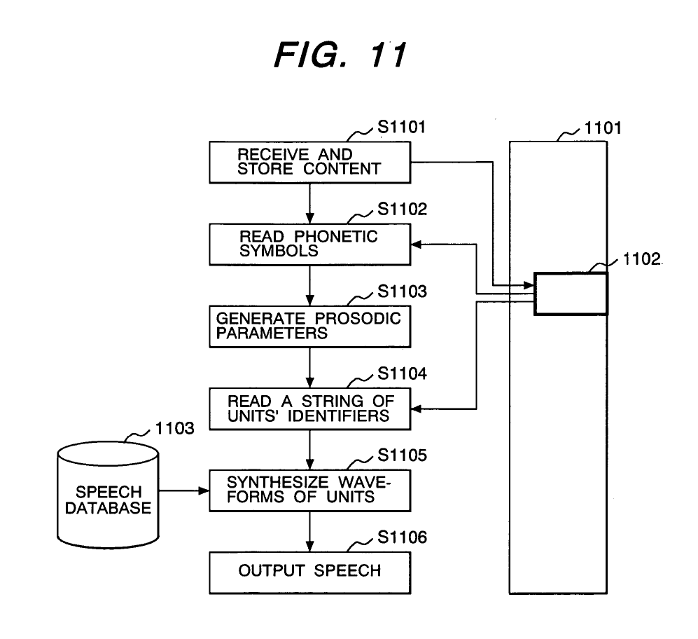

Next, another example of the steps for outputting speech at the terminal device 104 is described, using FIG. 11. This embodiment is suitable for the terminal device 104 with some affordable processing capacity. First, the terminal device 104 receives a secondary content from the processing server 101 and stores it into a content storage area 1102 in its memory 1101 (step S1101). Then, the terminal device reads a string of phonetic symbols from the content storage area 1102 (step S1102), generates prosodic parameters with regard to the phonetic symbols, and outputs prosodic information for the input text (step S1103).

For example, in the secondary content example described in FIG. 6A, the terminal device generates prosodic parameters with regard to the string of phonetic symbols (pron) “mamo' naku” and outputs prosodic information for the input text. Generating prosodic parameters in the above step S1003 can be performed in the same way as described for FIG. 7.

Then, in step S1104, the terminal device reads the string of the IDs of the units sent from the processing server 101 from the content storage area 1102. Next, in the waveform synthesis process, referring to the IDs of the units obtained in the preceding step, the terminal device retrieves the waveforms identified by those IDs from the speech database 1103, synthesizes the waveforms by using the same method as described for FIG. 8 (step S1105), and outputs speech from the speech output device 105 (step S1106). Through the above procedure, waveform synthesis using the string of optimal units set at the processing server can be performed.

By adding the step of generating prosodic parameters at the terminal device 104, means for synthesizing high-quality and smoother speech can be provided at the terminal device 104 without executing the optimal unit selection process with a high processing load.

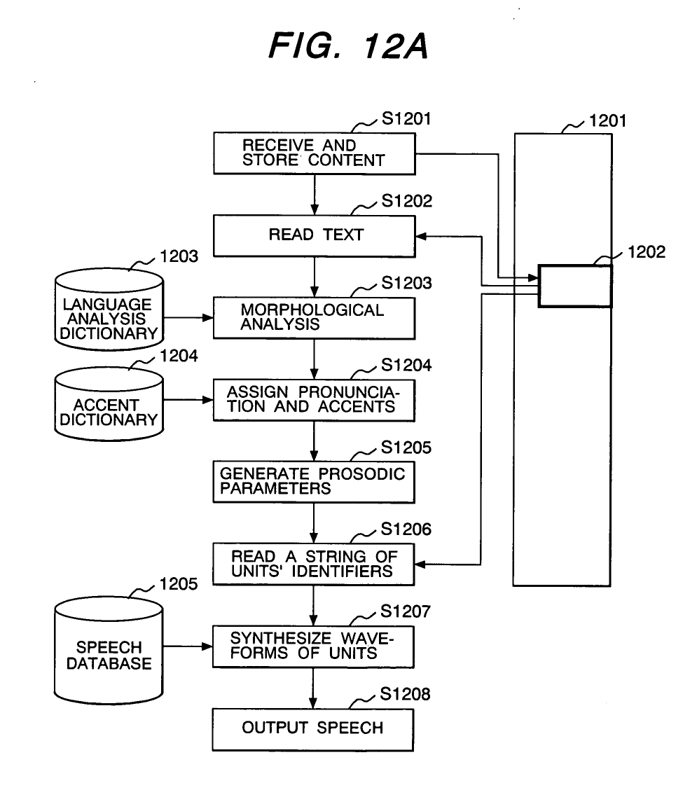

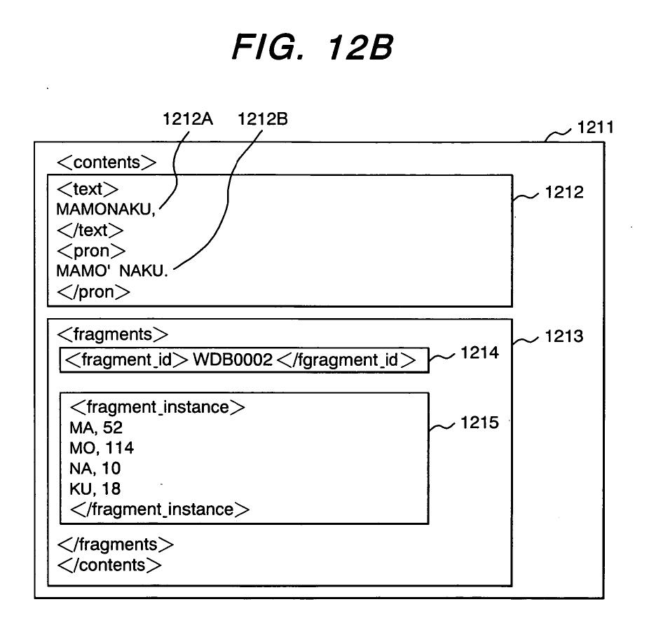

Next, another embodiment of the steps for outputting speech at the terminal device 104 is described, using FIGS. 12A and 12B. This embodiment is suitable for the terminal device 104 with some affordable processing capacity. In FIG. 12A, first, the terminal device 104 receives a secondary content from the processing server 101 and stores it into a content storage area 1202 in its memory 1201 (step S1201). Then, the terminal device reads the text from the content storage area 1202 (step S1202) and performs morphological analysis of the text by reference to the language analysis dictionary 1203 (step S1203).

For example, in an example of the secondary content 1211 described in FIG. 12B, when a string of mixed kanji and kana characters “mamonaku” is present as text 1212A in the text part 1212, it is converted to “mamo' naku” given an accent (pron) 1212B. For the results of morphological analysis, the terminal device then assigns pronunciations and accents by using the accent dictionary 1204 and generates a string of phonetic symbols (step S1204). For the string of phonetic symbols generated in the step S1204, the terminal device generates prosodic parameters and outputs prosodic information for the input text (step S1205). The above processing tasks from the step S1202 to the step S1205 can be performed in the same way as described for FIG. 7. In step S1206, the terminal device then reads the string of the IDs of the units sent from the processing server 101 from the content storage area 1202.

Next, in the waveform synthesis process, referring to the IDs of the units 1214 in the waveform information part 1213 obtained in the preceding step, the terminal device retrieves the waveforms identified by those IDs from the speech database 1205, according to the waveform index information 1215, synthesizes the waveforms (step S1207), and outputs speech from the speech output device 105. In the content example described in FIG. 12B, the optimal waveforms specified for the phonemes are retrieved from the speech database 1205 and, by concatenating the waveforms, synthesized speech is generated (step S1208).

Through the use of the above steps, means for synthesizing high-quality speech can be provided at the terminal device 104 without executing the optimal unit selection process with a high processing load. Besides, by executing morphological analysis of the input text by reference to the language analysis dictionary and generating prosodic parameters, the speech synthesis process can be performed at quite a high precision as a whole.

While the step of generating prosodic parameters and the step of morphological analysis shown in FIGS. 11 and 12 can be performed for all secondary contents, executing these steps may be conditioned so that these steps will be executed only for text data satisfying specific conditions.

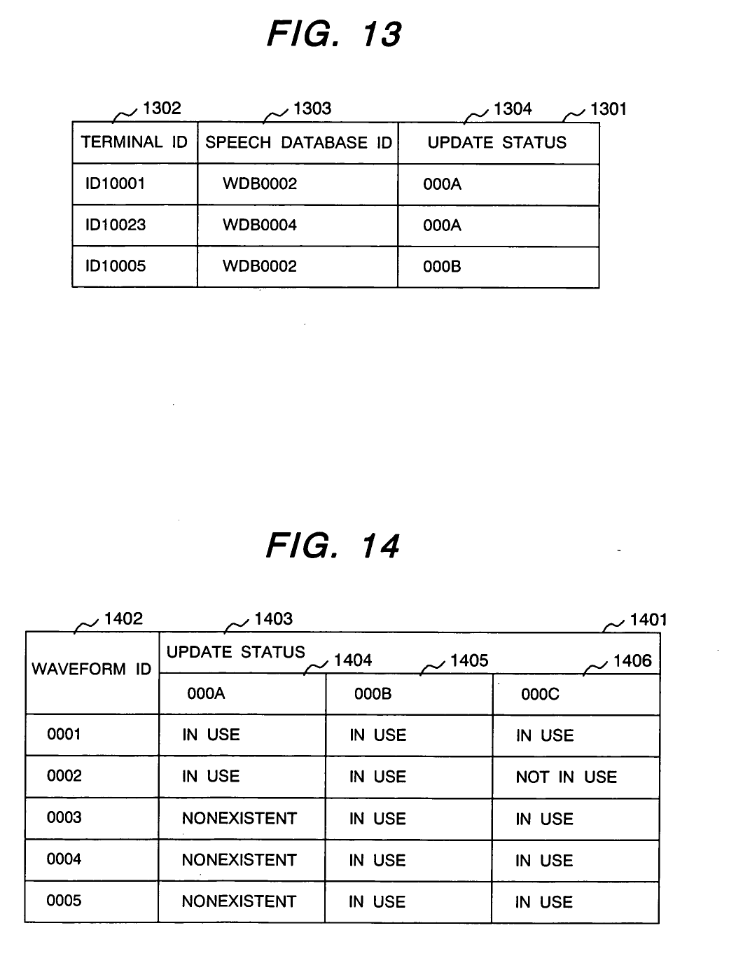

Next, an embodiment with regard to a speech database management method and an optimal selection method at the processing server 101 is discussed, using FIGS. 13 and 14. The processing server must update (revise up) the speech databases that are used for selecting units in order to improve voice quality.

For example, management of the speech databases is performed in a table form as shown in FIG. 13. In the management scheme shown in FIG. 13, in addition to the speech database management scheme shown in FIG. 5, the management is made with update IDs (revised up) to a same speech database ID. In FIG. 13, terminals “ID10001” and “ID10005” in the terminal ID column 1302 are associated with speech databases with the same ID of WDB0002 in the speech database ID column 1303, but the speech databases have different update IDs “000A” and “000B” in the update status column 1304. In fact, by using this management scheme, database management can be improved with information that the terminal with the “ID10001” and the terminal with the “ID10005” use different update statuses of the speech database.

Furthermore, at the processing server 101, information with regard to the IDs of the waveform units contained in a speech database are managed in a table form shown in FIG. 14. FIG. 14 shows an exemplary table for managing the update statuses of the waveform units regarding, e.g., the “ma” phoneme. The management table 1401 consists of a waveform ID 1402 column and an update status 1403 column. The update status 1403 column consists of update classes “000A” (1404), “000B” (1405), and “000C” (1406), depending on the update condition. For each update class, three levels of states “nonexistent,” “existing but not in use” and “in use” may be set for each waveform ID. For example, in the update class “000A,” a condition is set such that only the waveform IDs 1402 of “0001” and “0002” are in use and the information that the remaining waveform units are nonexistent is registered.

By using this management scheme, when the units belonging to the update class “000C” of update status 1403 are used, for a unit that is “not in use,” by setting its distance function f infinite, the unit is made unable to be used practically. Optimal units can be selected to be sent to a terminal having a speech database ID with the update class “000C” of update status 1403. The above distance function f is the same as the distance function described in the embodiment of FIG. 7.

The present invention is not limited to the embodiments described hereinbefore and can be used widely for a distribution server, processing server, terminal device, etc. included in a distribution service system. The text to be vocalized is not limited to text in Japanese and may be text in English or text in any other language.

What is claimed is:

1. A terminal device which can connect to a processing server via a network, said terminal device comprising:
a unit of receiving from said processing server a secondary content furnished with information for access to a speech database and retrieval of optimal units selected by analyzing text data included in a primary content distributed via said network; and
a unit of synthesizing speech corresponding to said text data, based on said secondary content and the speech database.

2. The terminal device according to claim 1, wherein a speech database exists on said processing server and this speech database and the speech database existing on said terminal device apply a common identification scheme in which a particular waveform can be identified uniquely.

3. The terminal device according to claim 1,
wherein said secondary content comprises a text part where text from said primary content and a string of phonetic symbols are stored and a waveform information part where reference information for the waveforms of said optimal units selected by analyzing data in the text part is described, and
wherein speech database ID information for identifying one of said speech databases and waveform index information for synthesizing speech corresponding to the data in said text part are stored in said waveform information part.

4. The terminal device according to claim 3, further comprising:
a unit of generating prosodic parameters with regard to the string of phonetic symbols included in said secondary content and outputting prosodic information for the data in said text part.

5. The terminal device according to claim 3, further comprising:
a unit of executing morphological analysis of the text included in said secondary content; and
a unit of generating prosodic parameters with regard to the string of phonetic symbols included in said secondary content and outputting prosodic information for the data in said text part.

6. A distributed speech synthesis system which includes a processing server and a terminal device connected to said processing server via a network, wherein said system implements speech synthesis and outputs speech from text data included in a primary content received over said network,
wherein said processing server comprises:
a unit of generating a secondary content, which comprises analyzing the text data included in the primary content received over said network, selecting optimal units, and furnishing information for access to a speech database and retrieval of the optimal units; and
a unit of sending the secondary content to said terminal device.

7. The distributed speech synthesis system according to claim 6,
wherein respective speech databases exist on said processing server and said terminal device, applying a common identification scheme in which a particular waveform can be identified uniquely.

8. The distributed speech synthesis system according to claim 7,
wherein said secondary content comprises a text part where text from said primary content and a string of phonetic symbols are stored and a waveform information part where reference information for the waveforms of said optimal units selected by analyzing data in the text part is described, and
wherein speech database ID information for identifying one of said speech databases and waveform index information for synthesizing speech corresponding to the text in said text part are stored in said waveform information part.

9. A computer program for speech synthesis and output from requested content data at a terminal device connected to a processing server via a network, said computer program causing a computer to implement:
a function of requesting said processing server for a primary content to be vocalized;
a function of receiving a secondary content including information of a string of optimal units selected by analyzing text data from said primary content from said processing server; and
a function of synthesizing speech from the secondary content data by accessing a speech database.

10. The computer program according to claim 9, wherein the speech database existing on said terminal device and a speech database existing on said processing server apply a common identification scheme in which a particular waveform can be identified uniquely.

11. The computer program according to claim 9,
wherein said secondary content comprises a text part where text from said primary content and a string of phonetic symbols are stored and a waveform information part where reference information for the waveforms of said optimal units selected by analyzing data in the text part is described, and
wherein said waveform information part comprises speech database ID information for identifying a speech database to access and waveform index information for identifying waveforms to be retrieved from the speech database identified by the database ID.

12. The computer program according to claim 9, further including:
a function of generating prosodic parameters with regard to the string of phonetic symbols included in said secondary content and outputting prosodic information for the data in said text part.

13. The computer program according to claim 9, further including:
a function of executing morphological analysis of the text included in said secondary content; and
a function of generating prosodic parameters with regard to the string of phonetic symbols included in said secondary content and outputting prosodic information for the data in said text part.

14. The computer program according to claim 9, wherein said terminal device is provided with a management table and the management table comprises a speech database and a terminal ID part as identifier information to identify said speech database existing on the terminal device.

15. The computer program according to claim 14, wherein said identifier information is managed by said processing server.

16. The computer program according to claim 14, which further causes the computer to implement a function of transmitting the identifier information to identify said speech database existing on said terminal device from the terminal device to said processing server over the network.

17. A computer program for distributed speech synthesis, which synthesizes and outputs speech from text data included in a primary content received over said network, in a distributed speech synthesis system including a processing server and a terminal device connected to said processing server via a network,
wherein respective speech databases exist on said processing server and said terminal device, applying a common identification scheme in which a particular waveform can be identified uniquely,
said computer program. causing a computer to implement:
a function of generating a secondary content, which comprises analyzing the text data included in the primary content received over said network, selecting optimal units, and furnishing information for access to a speech database and retrieval of the optimal units; and
a function of synthesizing speech corresponding to said text data, based on said secondary content and the appropriate speech database.

18. The computer program according to claim 17, which further causes the computer to implement:
a function of requesting said processing server for selecting optimal units by analyzing the primary content to be vocalized from said terminal device;
a function of generating the secondary content by the request at said processing server; and
a function of sending said secondary content to said processing server together with a request for content from said terminal device.

19. The computer program according to claim 17, which further causes the computer to implement:
a function of generating a secondary content including optimal units selected by analyzing the primary content to be vocalized, which is performed in advance at the processing server; and
a function of sending said secondary content to said processing server together with a request for content from said terminal device.

20. The computer program according to claim 17, which further causes the computer to implement:
a function of updating the speech databases to access for selecting optimal units with a management table comprising waveform IDs and update status data.
